(19) United States
(12) Patent Application Publication
(10) Pub. No.: US 2005/0068575 A1
(43) Pub. Date: Mar. 31, 2005

(54) Electronic apparatus that automatically distinguishes connected cable type and changes over to an operation mode corresponding to the cable

(75) Inventors: Tsuyoshi Yamamoto, Nagoya-shi (JP); Naoki Yoshida, Nagoya-shi (JP); Yoshitsugu Tomomatsu, Nagoya-shi (JP); Akihiko Niwa, Toki-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/919,388

(22) Filed: Aug. 17, 2004

(30) Foreign Application Priority Data
Sep. 29, 2003 (JP) 2003-336988

(51) Int. Cl. H01R 25/00; H01R 13/28; G06F 13/00; G06F 15/00; B41F 1/00; B41J 1/00; B41B 1/00; G06K 1/00

(52) U.S. Cl. 358/1.15; 710/100

(57) ABSTRACT

An electronic apparatus is capable of changing its operation mode to a specific mode for receiving a transmitted program and/or data simply by connecting a dedicated cable to the apparatus without any special work or control.

### BACKGROUND OF THE INVENTION

1. Field of Invention

The present invention relates to an electronic apparatus including a computer, such, for example, as a printer.

2. Description of Related Art

Generally, in an electronic apparatus including a computer such as, for example, a printer, its program and data used by the included computer are stored in an unrewritable ROM or in a rewritable nonvolatile memory (for example, a flash memory, EEPROM or the like). To update the version of a program or data, or to introduce a new program for maintenance, for repair or the like, if the program or data is stored in a ROM in this kind of the electronic apparatus, a substrate on which the ROM is fixed needs to be replaced. On the other hand, in the case of an electronic apparatus in which a program and data are stored in a nonvolatile memory thereof, the program and data stored in the nonvolatile memory can be rewritten by connecting that electronic apparatus to a host computer, and transmitting a desired program or data to the electronic apparatus. For example, Japanese Patent Application Laid-Open No. 1-112424 discloses a method for updating the version of an incorporated program by transmitting a file from a host computer to a laser printer, determining whether or not the file data is a program present in the laser printer that receives the file, and if the file is a new program, storing it in a program area of its nonvolatile memory and executing it when desired.

According to the method by which the substrate is replaced, its procedure is complicated and according to the method by file transfer described in Japanese Patent Application Laid-Open No. 1-112424, a special control to determine whether or not a transferred file is a program which should be stored in a program area is necessary.

### SUMMARY OF THE INVENTION

The present invention has been made to address a problem that it is difficult to rewrite a program or data used by a computer incorporated in an electronic apparatus such as a printer. Accordingly, one object of the present invention is to provide an electronic apparatus in which changing over to a specific mode such as a mode for transmitting the program or data is enabled without carrying out any special work or control.

To address the problem, one aspect of the present invention provides an electronic apparatus having: a connector that is connectable to a cable for connecting between the electronic apparatus and an external apparatus; determining means for determining whether or not a cable that is connected to the connector is a dedicated cable used for a predetermined application; and mode selecting means for, when the cable is determined to be a dedicated cable by the determining means, changing over to a predetermined mode.

According to one aspect of the invention, the determining means may determine whether or not the cable is a dedicated cable according to a signal input to a cable type determining terminal in the connector.

According to one aspect of the invention, the connector may be a connection interface to an external apparatus, which the electronic apparatus usually connects to, and the cable type determining terminal may be a terminal not used for connecting to the ordinary external apparatus.

According to one aspect of the invention, the connector may be provided on a substrate inside the electronic apparatus.

According to one aspect of the invention, the connector may connect a control module, for controlling the electronic apparatus, to an internal device provided inside the electronic apparatus, and the control portion may be a connector for transmitting data for controlling the internal device.

According to one aspect of the invention, the electronic apparatus may be a printing apparatus, the internal device may be a print head of the printing apparatus, and the connector may be a connector for transmitting print data to the print head of the printing apparatus.

If the electronic apparatus includes a memory medium that stores a rewritable control program, the predetermined mode may be a mode for rewriting the control program or data stored in the memory medium.

According to one aspect of the invention, the rewritable control program or data may be firmware for the electronic apparatus.

The firmware that is stored in the internal memory medium of the electronic apparatus may include both a control program and data to control the electronic apparatus.

Because the electronic apparatus of aspects of the present invention automatically changes the mode if it is determined that the cable connected to the connector is a dedicated cable, no special control for determining the kind of data transmitted through the cable is necessary.

If terminals are connected in the dedicated cable so that a signal corresponding to the kind of the cable is input to a cable type determining terminal in the connector, the electronic apparatus can determine that it is the dedicated cable simply by connecting the cable to the connector.

The interface connector used ordinarily for connecting to an external apparatus may be used as a connector on which to connect the dedicated cable. Consequently, the mode selection can be carried out easily using an existing connector without preparing any special connector.

Further, the connector on which the dedicated cable is loaded may be provided on a substrate inside the electronic apparatus. Consequently, the structure of the connector can be designed freely by preparing a connector on which a dedicated cable for mode selection is to be loaded.

Further, as a connector on which the dedicated cable is loaded, it is permissible to use an ordinarily prepared connector for transmitting data from the control portion to the internal device. Consequently, the mode can be changed over easily without preparing any special connector.

If the electronic apparatus is a printing apparatus, the connector used ordinarily for transmitting print data can be used as a connector to which the dedicated cable is connected, thereby necessitating no special reconstruction or the like of the printing apparatus.

Further, if the electronic apparatus has a rewritable memory medium to store the control program or data, the operation mode of the electronic apparatus can be changed to a dedicated mode for rewriting the control program or data by connecting the dedicated cable to the connector. By preparing the dedicated mode, the control program or data can be rewritten without any special control for determining the type of data to be input from the connector. Further, because the operation mode can be changed to the dedicated mode simply by connecting the dedicated cable to the connector, even an inexperienced user can execute the re-programming operation with few mistakes. Further, because this is a dedicated mode, even if a fault occurs during reception of the control program or data, it is possible to construct so as to enable rewriting of the control program or data without affecting other controls.

Further, because the operation mode of the electronic apparatus is changed to the dedicated mode for rewriting the firmware by connecting the dedicated cable to the connector, the firmware can be rewritten easily. Consequently, no troublesome operation for changing the operation mode to the firmware rewriting dedicated mode is required, so that the newest firmware can be used easily.

### BRIEF DESCRIPTION OF THE DRAWINGS

Preferred, exemplary embodiments of the invention will be described in conjunction with the accompanying drawings in which:

FIG. 1 is a perspective view showing the appearance of a printing apparatus implementing aspects of the invention;

FIG. 2 is a perspective view showing a state in which the rear face cover of the FIG. 1 printing apparatus is removed as seen from the rear side;

FIG. 3 is a block diagram showing the electrical structure of the FIG. 1 printing apparatus;

FIG. 4 is a front view of a face of a dedicated cable to be connected to a serial connector of the FIG. 1 printing apparatus;

FIG. 5 is a connection diagram of terminals of the special cable that is usable with the invention; and

FIG. 6 is a flow chart showing the flow of mode changeover processing according to aspects of the invention.

### DETAILED DESCRIPTION OF EXEMPLARY EMBODIMENTS

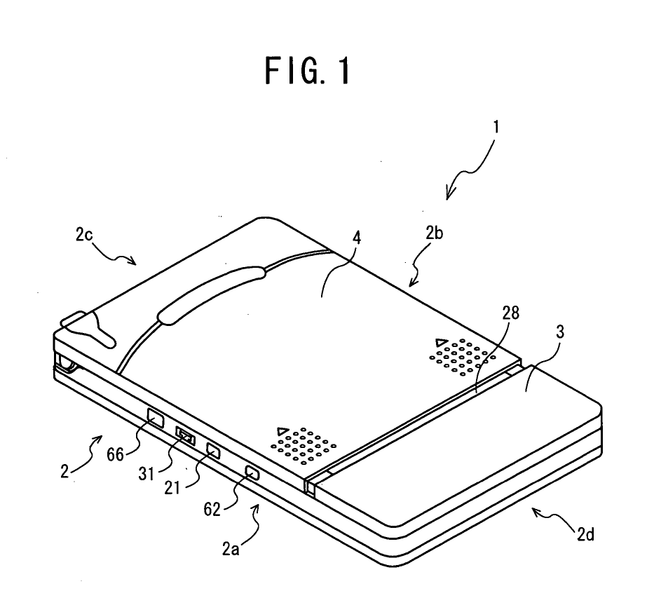

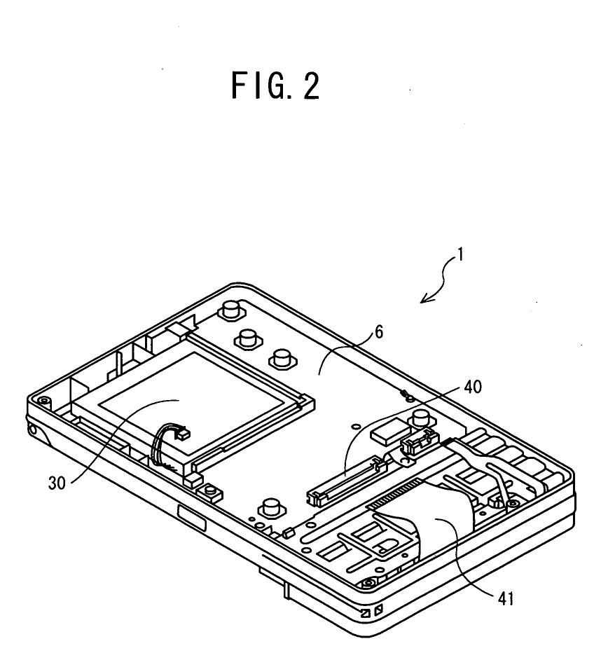

Preferred, exemplary embodiments of the present invention will be described with reference to the accompanying drawings. First, the structure of the printing apparatus 1 showing an example of an electronic apparatus implementing the present invention will be described with reference to FIGS. 1 and 2. FIG. 1 is a perspective view showing the appearance of a printing apparatus 1. FIG. 2 is a perspective view showing a state in which the rear face cover of the printing apparatus 1 is removed as seen from the rear side.

As shown in FIGS. 1 and 2, the main body case 2 of the printing apparatus 1 is substantially rectangular in its plan view, more specifically a substantially A6 size shape having a length of about 16 cm and a width of about 10 cm and a rectangular solid having a depth of about 2 cm. The main body case 2 has case side faces 2a, 2b, 2c, and 2d and various kinds of interfaces are disposed along the length direction of the case side face 2a. An AC adaptor connector 62 for receiving power, a serial connector 21 for executing serial communication with an external apparatus, a USB connector 31 for communicating with an external apparatus based on the USB standard, and a power switch 66 for turning ON/OFF the power of the printing apparatus 1 are provided on the case side face 2a in this order from the right side thereof.

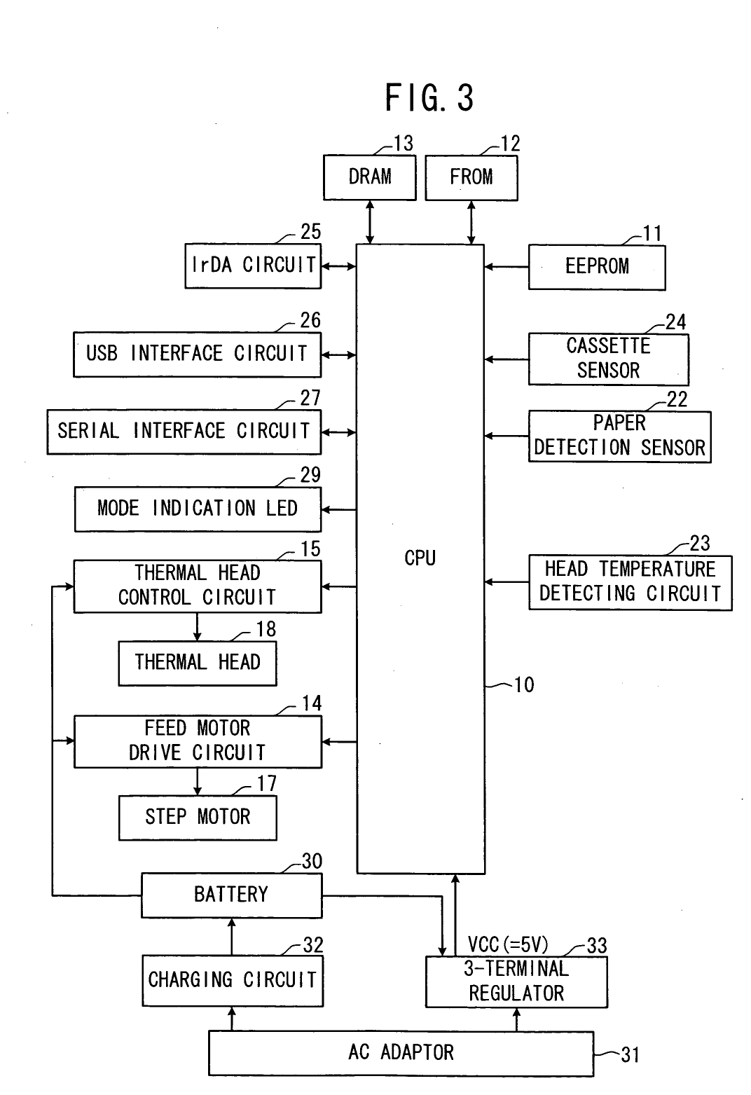

A substantially rectangular fixed cover 3 is provided on the top face near an end in the length direction of the main body case 2, occupying about ¼ area in the top face of the main body. A printing mechanism portion having a paper feed roller for feeding paper (not shown), a thermal head 18 (see FIG. 3) which prints by heating and the like is provided inside the portion of the main body case 2 covered with the fixed cover 3. An accommodation portion (not shown) which accommodates paper to be printed is provided in a portion other than the portion under the fixed cover 3 of the top face of the main body case 2, and is covered with a case cover 4. A discharge port 28 for discharging a printed paper from the printing mechanism portion is provided between the fixed cover 3 and the case cover 4.

A control circuit board 6 (main substrate) having a CPU 10 (see FIG. 3) for controlling the printing apparatus 1, an internal connector 40 for transmitting/receiving print data, a DRAM 13, a FROM 12, an EEPROM 11 (see FIG. 3) and other various circuits, and a battery 30 for supplying power to the printing apparatus 1 are provided below the accommodation portion. The rear face of the main body case 2 is covered with a rear face cover (not shown), and by removing the rear face cover, the control circuit board 6, the internal connector 40 and a flat cable 41 can be accessed. The flat cable 41 is for transmitting print data from the CPU 10 to a thermal head 18, and is mounted to the internal connector 40.

To make the size of the printing apparatus 1 compact, the printing apparatus 1 utilizes the thermal head 18 as its printing head and thermal paper as a printing medium. The reason why the thermal head 18 is utilized as the printing head is that no reciprocating mechanism is required, unlike most ink jet type or ink ribbon type printing heads, thereby achieving reduction in size. Further, its economic efficiency is excellent because the only required consumption good is paper. As the thermal paper, a thermal color development type, which has a color development layer in which dye and developer chemically combine with each other when heated by the thermal head to develop a color, a thermal boring type in which a boring layer which is bored by heating is formed on a base layer thereof and the like are available. The invention, however, is applicable to other types of printers such as, for example, the above-noted ink jet printers, laser printers, etc.

Next, the electrical structure of the printing apparatus 1 will be described with reference to FIG. 3. FIG. 3 is a block diagram showing the electrical structure of the printing apparatus 1. The EEPROM 11, FROM 12, and DRAM 13 are connected to the CPU 10 that controls the printing apparatus 1. The EEPROM 11 stores model information, production number, count information of print number, and maintenance information such as information specific to an individual printing apparatus 1. The FROM 12 stores control programs and data used for printing such as character data and graphic data, and if the operation mode is changed to rewrite mode by connecting a dedicated cable 42, as described later, the contents of the control program and data stored in the FROM 12 can be rewritten. Further, data values which occur during arithmetic operations are stored temporarily in the DRAM-13.

The printing mechanism portion of the printing apparatus 1 includes a step motor 17 that feeds paper, a thermal head 18 that prints by heating, a feed motor drive circuit 14 that drives the step motor 17 and a thermal head control circuit 15 that controls the thermal head 18. The thermal head control circuit 15 and the feed motor drive circuit 14 are driven according to an instruction from the CPU 10 to execute printing.

Various kinds of sensors and detecting circuits such as a cassette sensor 24 that detects whether or not a paper cassette (not shown) is loaded, a paper detection sensor 22 that detects whether or not a thermal paper is located at printing position and a head temperature detecting circuit 23 that detects the temperature of the thermal head 18 are connected to the CPU 10 so that detection results are input thereto. Further, an IrDA circuit 25, a USB interface circuit 26 that achieves USB connection and a serial interface circuit 27 that executes serial connection are connected to the CPU 10 to execute communication with external apparatus through these components. A mode indication LED 29 is connected to the CPU 10 to indicate the mode of the printing apparatus 1 (e.g., printing, data writing, program rewriting, and the like) through an indication state or color, for example.

The printing apparatus 1 contains a battery 30 composed of a lithium ion battery which is rechargeable by a charging circuit 32 when connected to an AC adaptor 31, and this battery 30 supplies the printing apparatus 1 with power. The battery 30 is connected to the thermal head control circuit 15 and to the motor drive circuit 14 to supply power to these circuits, and further is connected to a three-terminal regulator 33. The voltage is regulated to 5V by the three-terminal regulator 33 and then supplied to the CPU 10. Of course, the apparatus also could use a non-rechargeable battery.

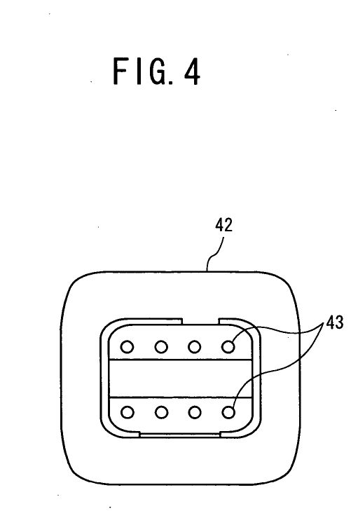

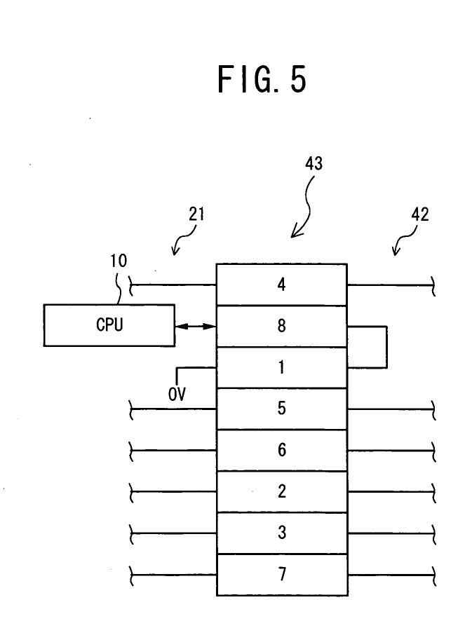

Next, the dedicated cable 42 to be connected to the serial connector 21 of this embodiment of the invention will be described with reference to FIGS. 4 and 5.

FIG. 4 is a front view of a face of a dedicated cable 42 to be connected to a serial connector 21. FIG. 5 is a schematic diagram showing a connection diagram of terminals 43 of the dedicated cable 42. In FIG. 5, the right side indicates the side of the dedicated cable 42 and the left side indicates the side of the serial connector 21.

As shown in FIG. 4, the dedicated cable 42 to be connected to the serial connector 21 is similar to a general purpose serial cable for transmitting print data from an external apparatus such as, for example, a personal computer, or any other portable information terminal, to the printing apparatus 1. The serial connector 21 has eight terminals for transmitting/receiving signals, and the dedicated cable 42 has eight terminals 43 corresponding to these terminals just like a general purpose serial cable.

When the general purpose serial cable is connected to the serial connector 21, of the eight terminals of the serial connector 21, six terminals are used for transmitting/receiving ordinary data such as print data. For example, if numbers 1-8 are allocated to the terminals as shown in FIG. 5, the terminals 2-7 are used for transmitting/receiving data. The remaining two terminals are not used for transmitting/receiving ordinary data, and remain as empty terminals. One of them is connected to the CPU 10 within the printing apparatus 1 (terminal No. 8 in FIG. 5) while the other is grounded (terminal No. 1 in FIG. 5). Thus, because the terminal No. 8 is not grounded when the ordinarily used general purpose serial cable is connected to the serial connector 21, a high level signal is input to the CPU 10. The terminals 1 and 8 can be considered to be redundant terminals because they are not used under normal conditions. These terminals also are not used for the transmission of data.

In the dedicated cable 42 of one embodiment of the invention, as shown in FIG. 5, terminals No. 1 and No. 8 are connected to each other in the dedicated cable 42. Thus, if the dedicated cable 42 is connected to the serial connector 21, the terminal No. 8 of the serial connector 21 is connected to the CPU 10 and the terminal No. 1 is grounded to 0V, so that 0V signal, that is, a low level signal is input into the CPU 10 through the terminal No. 8 from the terminal No. 1. When the dedicated cable 42 is so connected, the low level signal is input to the CPU 10, unlike when the ordinary general purpose cable is connected, so that the CPU 10 is capable of recognizing immediately that the dedicated cable 42 is connected. Therefore, mode selection is enabled according to a signal input from the terminal No. 8 of the serial connector 21. Hereinafter, the terminal No. 8 of the serial connector 21 will be called the mode selection terminal.

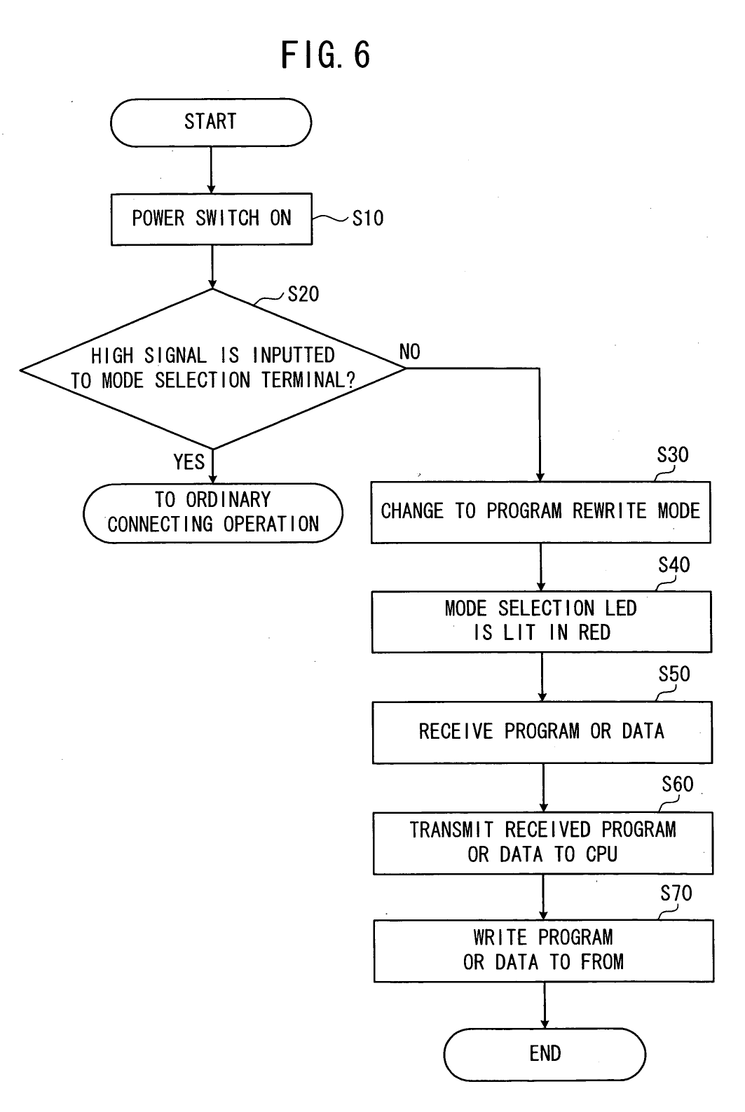

Next, the operation of the printing apparatus 1 having such a structure will be described with reference to FIG. 6. FIG. 6 is a flow chart showing the flow of mode selection processing. If, as shown in FIG. 6, the power switch is turned ON (S10), it is determined whether or not the high level signal is input to the mode selection terminal (terminal No. 8 in FIG. 5) (S20). If the high level signal is input to the mode selection terminal (S20: YES), it can be determined that the terminals No. 1 and No. 8 are connected with an ordinary cable and therefore printing is executed according to ordinary connecting action.

If the high level signal is not input to the mode selection terminal (S20: NO), then the appropriate terminal of the serial connector 21 is connected to the mode selection terminal within the cable, and therefore it can be determined that a dedicated cable having a structure according to this embodiment of the invention is connected. Then, the mode is changed to program rewrite mode (S30) and the mode selection LED is lit in red (S40). Next, a control program such as, for example, firmware or data such as character data and graphic data are received from an external apparatus (S50), and if the reception ends, that program or data is transmitted to the CPU 10 and written into the internal RAM of the CPU 10 (S60). Next, instead of the previously stored control program and/or data, the newly downloaded program or data stored in the internal RAM is written into the FROM 12 (S70) and then the processing ends.

If terminals not used ordinarily in the dedicated cable 42 are connected to each other according to this embodiment, as described above, when the dedicated cable 42 is connected to the printing apparatus 1, and the printing apparatus 1 is powered ON, the low level signal is input to the CPU 10. Because usually the high level signal is input to this mode selection terminal, the CPU can determine immediately that the dedicated cable 42 is connected. Therefore, just after the cable is connected, it is possible to change the mode and execute download of data and/or program. Therefore, no special control of determining the kind of transmitted data and distinguishing from an ordinary action, such as reception of print data, is required. Further, because the mode selection is automatically carried out if the dedicated cable 42 is connected, even if any fault such as an operation interruption occurs during downloading of data and/or program, only a sequence of operations, namely, reception and write of data and/or program from the downloading, needs to be re-executed. Consequently, it is possible to avoid such a fault that normal version updating or reset is disabled as a result of a stoppage of the electronic apparatus during rewriting of the firmware.

According to this embodiment, in S20 of the flow chart shown in FIG. 6, the CPU 10 which determines whether or not an input signal to the mode selection terminal is high functions as determining means, and the CPU 10 which executes the mode selection processing in S30 functions as mode selection means.

Although according to this embodiment, the dedicated cable 42 to be connected to the serial connector 21 is used as the dedicated cable, the dedicated cable is not restricted to a serial cable. Rather, any kind of cable may be used as long as it has terminals usable for mode selection. For example, because the flat cable 41 and the internal connector 40 connecting the thermal head 18, which can be accessed when the rear face of the printing apparatus 1 is opened, are dedicated components of the printing apparatus 1 as shown in FIG. 2, they can be provided with dedicated terminals for mode selection.

For example, it also is permissible to execute processing of each mode by preparing a terminal capable of corresponding to plural modes in the internal connector 40 and then, preparing a dedicated cable meeting the kind of data write and program, rewrite and connecting to the internal connector 40.

In the illustrated embodiment, the controller (CPU 10) preferably is implemented using a suitably programmed general purpose computer, e.g., a microprocessor, microcontroller or other processor device (CPU or MPU). It will be appreciated by those skilled in the art, that the controller also can be implemented as a single special purpose integrated circuit (e.g., ASIC) having a main or central processor section for overall, system-level control, and separate sections dedicated to performing various different specific computations, functions and other processes under control of the central processor section. The controller also can be implemented using a plurality of separate dedicated or programmable integrated or other electronic circuits or devices (e.g., hardwired electronic or logic circuits such as discrete element circuits, or programmable logic devices such as PLDs, PLAs, PALs or the like). The controller also can be implemented using a suitably programmed general purpose computer in conjunction with one or more peripheral (e.g., integrated circuit) data and signal processing devices. In general, any device or assembly of devices on which a finite state machine capable of implementing the described procedures can be used as the controller of the invention.

While the invention has been described with reference to exemplary embodiments, it is to be understood that the invention is not limited to the exemplary embodiments or constructions. While the various elements of the exemplary embodiments are shown in various combinations and configurations, which are exemplary, other combinations and configurations, including more, less or only a single element, are also within the spirit and scope of the invention.

1. An electronic apparatus comprising:
a connector that is connectable to a cable for connecting between the electronic apparatus and an external apparatus;
determining means for determining whether or not a cable connected to the connector is a dedicated cable used for a predetermined application; and
mode selecting means for, when the cable is determined to be the dedicated cable by the determining means, changing over to a predetermined mode.

2. The electronic apparatus according to claim 1, wherein the determining means determines whether or not the cable is the dedicated cable according to a signal input to a redundant terminal of the connector.

3. The electronic apparatus according to claim 2, wherein the connector is a connection interface to an external apparatus.

4. The electronic apparatus according to claim 2, wherein the connector is provided on a substrate inside the electronic apparatus.

5. The electronic apparatus according to claim 4, wherein the connector connects a control module that controls the electronic apparatus to an internal device provided inside the electronic apparatus, and the connector transmits data for controlling the internal device.

6. The electronic apparatus according to claim 5, wherein the electronic apparatus is a printing apparatus, the internal device is a print head of the printing apparatus, and the connector is a connector to transmit print data to the print head of the printing apparatus.

7. The electronic apparatus according to claim 1, wherein the connector is a connection interface to the external apparatus.

8. The electronic apparatus according to claim 7, further comprising a rewritable memory medium, wherein the predetermined mode is a mode for storing at least one of a control program and data in the memory medium.

9. The electronic apparatus according to claim 8, wherein at least one of the rewritable control program and the data is firmware for the electronic apparatus.

10. The electronic apparatus according to claim 1, wherein the connector is provided on a substrate inside the electronic apparatus.

11. The electronic apparatus according to claim 10, wherein the connector connects a control module that controls the electronic apparatus to an internal device provided inside the electronic apparatus, and the connector transmits data for controlling the internal device.

12. The electronic apparatus according to claim 11, wherein the electronic apparatus is a printing apparatus, the internal device is a print head of the printing apparatus, and the connector is a connector to transmit print data to the print head of the printing apparatus.

13. The electronic apparatus according to claim 1, further comprising a memory medium that stores a rewritable control program, wherein the predetermined mode is a mode for rewriting at least one of a control program and data in the memory medium.

14. The electronic apparatus according to claim 13, wherein at least one of the rewritable control program and the data is firmware for the electronic apparatus.

15. An electronic apparatus comprising:
a connector that is connectable to a cable for connecting between the electronic apparatus and an external apparatus;
determining means for determining whether or not a cable connected to the connector is a dedicated cable used for a predetermined application; and
mode selecting means for, when the cable is determined to be the dedicated cable by the determining means, changing over to a predetermined mode,
wherein the connector is a connection interface to an external apparatus.

16. The electronic apparatus according to claim 15, wherein the determining means determines whether or not the cable is the dedicated cable according to a signal input to a redundant terminal of the connector.

17. The electronic apparatus according to claim 16, further comprising a rewritable memory medium, wherein the predetermined mode is a mode for storing at least one of a control program and data in the memory medium.

18. The electronic apparatus according to claim 17, wherein at least one of the rewritable control program and the data is firmware for the electronic apparatus.

19. An electronic apparatus comprising:
a connector that is connectable to a cable for connecting between the electronic apparatus and an external apparatus;
determining means for determining whether or not a cable connected to the connector is a dedicated cable used for a predetermined application; and
mode selecting means for, when the cable is determined to be the dedicated cable by the determining means, changing over to a predetermined mode, wherein the connector is provided on a substrate located inside the electronic apparatus.

20. The electronic apparatus according to claim 19, wherein the determining means determines whether or not the cable is the dedicated cable according to a signal input to a redundant terminal of the connector.

21. The electronic apparatus according to claim 20, wherein the connector connects a control module that controls the electronic apparatus to an internal device provided inside the electronic apparatus, and the connector transmits data for controlling the internal device.

22. The electronic apparatus according to claim 21, wherein the electronic apparatus is a printing apparatus, the internal device is a print head of the printing apparatus, and the connector is a connector to transmit print data to the print head of the printing apparatus.

23. The electronic apparatus according to claim 22, further comprising a rewritable memory medium, wherein the predetermined mode is a mode for storing at least one of a control program and data in the memory medium.

24. The electronic apparatus according to claim 23, wherein at least one of the rewritable control program and the data is firmware for the electronic apparatus.

25. An electronic apparatus comprising:
a connector that is connectable to a second connector in order to connect the electronic apparatus with an external apparatus to which the second connector is coupled; and
a controller that:
determines whether or not the second connector connected to the connector is a dedicated second connector used for a predetermined application; and
changes to a predetermined mode when the second connector is determined to be the dedicated second connector.

26. The electronic apparatus according to claim 25, wherein the controller determines whether or not the second connector is the dedicated second connector according to a signal input to a redundant terminal of the connector.

27. The electronic apparatus according to claim 26, wherein the connector is a connection interface to an external apparatus.

28. The electronic apparatus according to claim 26, wherein the connector is provided on a substrate inside the electronic apparatus.

29. The electronic apparatus according to claim 28, wherein the connector connects a control module that controls the electronic apparatus to an internal device provided inside the electronic apparatus, and the connector transmits data for controlling the internal device.

30. The electronic apparatus according to claim 29, wherein the electronic apparatus is a printing apparatus, the internal device is a print head of the printing apparatus, and the connector is a connector to transmit print data to the print head of the printing apparatus.

31. The electronic apparatus according to claim 25, wherein the connector is a connection interface to the external apparatus.

32. The electronic apparatus according to claim 31, further comprising a rewritable memory in the electronic apparatus, wherein the predetermined mode is a mode for storing at least one of a control program and data in the memory.

33. The electronic apparatus according to claim 25, wherein the connector is provided on a substrate inside the electronic apparatus.

34. The electronic apparatus according to claim 33, wherein the connector connects a control module that controls the electronic apparatus to an internal device provided inside the electronic apparatus, and the connector transmits data for controlling the internal device.

35. The electronic apparatus according to claim 34, wherein the electronic apparatus is a printing apparatus, the internal device is a print head of the printing apparatus, and the connector is a connector to transmit print data to the print head of the printing apparatus.

36. The electronic apparatus according to claim 25, further comprising a rewritable memory in the electronic apparatus, wherein the predetermined mode is a mode for storing at least one of a control program and data in the memory.

37. The electronic apparatus according to claim 25, wherein the controller determines that the second connector is the dedicated second connector when a signal provided on at least one terminal of the second connector has a first value, and determines that the second connector is not the dedicated second connector when the signal provided on the at least one terminal of the second connector has a second value that is different from the first value.

38. A printing apparatus comprising:
a connector that is connectable to a second connector in order to connect the printing apparatus with an external apparatus to which the second connector is coupled; and
a controller that:
determines whether or not the second connector connected to the connector is a dedicated second connector used for downloading at least one of a program and data; and
automatically changes to a downloading mode of operation when the second connector is determined to be the dedicated second connector.

39. A method of controlling an electronic apparatus, the method comprising:
determining whether a connector of the electronic apparatus is connected to a second connector which connects the electronic apparatus with an external apparatus to which the second connector is coupled;
determining whether or not the second connector connected to the connector is a dedicated second connector used for a predetermined application; and
automatically changing the electronic apparatus to a predetermined mode when the second connector is determined to be the dedicated second connector.

40. The method according to claim 39, wherein the step of determining whether or not the second connector is the dedicated second connector is performed based upon a signal input to a redundant terminal of the connector from the second connector.

41. The method according to claim 40, wherein the connector is a connection interface to an external apparatus.

42. The method according to claim 40, wherein the connector is provided on a substrate inside the electronic apparatus.

43. The method according to claim 42, wherein the connector connects a control module that controls the electronic apparatus to an internal device provided inside the electronic apparatus, and the connector transmits data for controlling the internal device.

44. The method according to claim 43, wherein the electronic apparatus is a printing apparatus, the internal device is a print head of the printing apparatus, and the connector is a connector to transmit print data to the print head of the printing apparatus.

45. The method according to claim 39, wherein the connector is a connection interface to the external apparatus.

46. The method according to claim 45, wherein the electronic apparatus includes a rewritable memory, wherein the predetermined mode is a mode in which at least one of a control program and data is stored in the memory.

47. The method according to claim 39, wherein the connector is provided on a substrate inside the electronic apparatus.

48. The method according to claim 47, wherein the connector connects a control module that controls the electronic apparatus to an internal device provided inside the electronic apparatus, and the connector transmits data for controlling the internal device.

49. The method according to claim 48, wherein the electronic apparatus is a printing apparatus, the internal device is a print head of the printing apparatus, and the connector is a connector to transmit print data to the print head of the printing apparatus.

50. The method according to claim 39, wherein the electronic apparatus includes a rewritable memory, wherein the predetermined mode is a mode in which at least one of a control program and data is stored in the memory.

51. The method according to claim 39, wherein the determining step determines that the second connector is the dedicated second connector when a signal provided on at least one terminal of the second connector has a first value, and determines that the second connector is not the dedicated second connector when the signal provided on the at least one terminal of the second connector has a second value that is different from the first value.

52. A method of controlling a printing apparatus, the method comprising:
determining whether a connector of the printing apparatus is connected to a second connector which connects the printing apparatus with an external apparatus to which the second connector is coupled;
determining whether or not the second connector connected to the connector is a dedicated second connector used for downloading at least one of a program and data; and
automatically changing the printing apparatus to a downloading mode of operation when the second connector is determined to be the dedicated second connector.
